(19) United States
(12) Patent Application Publication
(10) Pub. No.: US 2026/0301377 A1
(43) Pub. Date: Oct. 1, 2026

(54) SCALABLE FOUNDATION MODEL FOR THREE-DIMENSIONAL SCENE UNDERSTANDING

(71) Applicant: QUALCOMM Incorporated, San Diego, CA (US)

(72) Inventors: Venkatraman Narayanan, Northville, MI (US); Varun Ravi Kumar, San Diego, CA (US); Senthil Kumar Yogamani, San Diego, CA (US)

(21) Appl. No.: 19/089,334

(22) Filed: Mar. 25, 2025

(51) Int. Cl. G06V 10/774; G01S 17/42; G01S 17/89; G06V 10/26; G06V 10/82; G06V 20/58; G06V 20/70

(52) U.S. Cl. CPC G06V 10/774; G01S 17/42; G01S 17/89; G06V 10/26; G06V 10/82; G06V 20/58; G06V 20/70

(57) ABSTRACT

Certain aspects of the disclosure provide for the development of a scalable foundation model for three-dimensional perception and scene understanding. A two-stage training approach is utilized that combines supervised learning on labeled three-dimensional sensor data in the first stage and self-supervised learning on large, unlabeled sensor datasets in the second stage. Further, online learning can be performed to address unknown objects, among other things, given human input. The foundation model can include a multimodal large language model that generates text-based object descriptions of three-dimensional sensor data, a fusion transformer that combines the text-based object descriptions with the three-dimensional data to generate a multimodal representation, and a transformer decoder that performs perception and scene understanding tasks.

### FIELD

Aspects of the subject disclosure relate to foundation models and, more particularly, three-dimensional scene understanding.

### BACKGROUND

A foundation model is a large-scale deep learning model trained on vast and diverse data sets to develop a generalized representation of data across multiple domains. The generalized representation captures a broad understanding of data that enables performance of a wide range of tasks across various applications. A foundation model can serve as a base model that can be further adapted for specific purposes through fine-tuning. Building foundation models is highly resource-intensive, including expenses associated with acquiring and processing massive data sets as well as compute power for training. By contrast, adapting or customizing an existing foundation model for a specific task is far less costly, as it leverages pre-trained capabilities and performs fine-tuning on smaller and task-specific datasets.

### SUMMARY

The following summary provides a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

Briefly described, various methods, apparatuses, and systems relate to the development of a foundation model for three-dimensional perception and scene understanding. A hybrid two-stage training approach can be employed that utilizes supervised learning on labeled three-dimensional sensor data in the first training stage and self-supervised learning on unlabeled three-dimensional sensor data in the second training stage. The first training stage provides a first level of training from limited labeled sensor data. The second training stage builds on the first training stage with large unlabeled sensor data that can scale and adapt the foundation model to diverse scenarios. Online learning can also be employed in the training process, triggering human-in-the-loop review and feedback that can be incorporated into the foundation model allowing the foundation model to continuously adapt and handle unexpected situations. The foundation model can further be fined-tuned to target a particular problem space such as autonomous driving.

Certain aspects provide a method comprising obtaining labeled three-dimensional sensor data, training a foundation model on three-dimensional scene understanding based on the labeled three-dimensional sensor data a first training stage, wherein the foundation model comprises a multimodal large language model (LLM) encoder, a fusion transformer, and a transformer decoder, obtaining unlabeled three-dimensional sensor data, and training the foundation model trained in the first training stage based on the unlabeled three-dimensional sensor data in a second training stage.

Other aspects provide an apparatus comprising one or more memories and processing circuitry in communication with the one or more memories. The processing circuitry is configured to obtain labeled three-dimensional sensor data, train a foundation model on three-dimensional scene understanding based on the labeled three-dimensional sensor data in a first training stage, wherein the foundation model comprises a multimodal large language model (LLM) encoder, a fusion transformer, and a transformer decoder, obtain unlabeled three-dimensional sensor data, and train the foundation model trained in the first training stage based on the unlabeled three-dimensional sensor data in a second training stage.

Further aspects provide a method comprising obtaining three-dimensional sensor data, identifying one or more objects in the three-dimensional sensor data, determining one or more object features of the one or more objects, invoking a multimodal large language model (LLM) encoder that generates one or more text-based object descriptions of one or more objects in the three-dimensional sensor data, invoking a fusion transformer that combines object features and the one or more text-based object descriptions to produce a multimodal representation, and invoking a transformer decoder that performs a three-dimensional perception task based on multimodal representation.

To the accomplishment of the foregoing and related ends, certain illustrative aspects of the claimed subject matter are described herein in connection with the following description and annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### DESCRIPTION OF THE DRAWINGS

The appended figures depict certain aspects and are therefore not to be considered limiting of the scope of this disclosure.

FIG. 1 is a block diagram illustrating an example computing device with which aspects of the subject disclosure can be performed.

FIG. 2 is a block diagram of an example implementation of a foundation model.

FIG. 3 illustrates an example of two-stage training of a foundation model.

FIG. 4 is a flow chart diagram illustrating an example method foundation model inferencing.

FIG. 5 is a flow chart diagram depicting an example method of two-stage training of a foundation model.

FIG. 6 is a flow chart diagram illustrating an example method of stage one training.

FIG. 7 is a flow chart diagram illustrating an example method of stage two training.

FIG. 8 is a flow chart diagram depicting an example method of online learning.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for developing a scalable foundation model for three-dimensional scene understanding.

Three-dimensional scene understanding can refer to the ability of a system to interpret and comprehend a three-dimensional environment and can involve recognizing objects, their spatial relationships, and the overall layout of a scene. Three-dimensional scene understanding builds on three-dimensional perception, which collects sensor data and builds a representation of an environment by analyzing and reasoning about the scene.

Three-dimensional scene understanding is beneficial for autonomous driving and advanced driver assistance systems (ADAS) because it allows vehicles to interpret their surroundings, predict object movements, and make safe driving decisions. For example, three-dimensional scene understanding can distinguish between static objects, such as buildings, and dynamic objects, such as moving cars and pedestrians. Three-dimensional scene understanding tasks can utilize three-dimensional sensors to enable safe navigation and decision-making in dynamic environments.

Three-dimensional sensors are devices that provide spatial awareness and depth perception. For example, light detection and ranging (LiDAR) is a three-dimensional sensor that uses laser pulses to create high-resolution three-dimensional maps of an environment. Unlike traditional cameras that rely on ambient light, many three-dimensional sensors operate independently of lighting conditions and can perform reliability in poor lighting conditions and adverse weather such as rain or fog. Three-dimensional sensors, such as LiDAR, can, therefore, enable autonomous vehicles or robots, among other things, to navigate safely and efficiently even in diverse conditions.

Unlike established foundation models in two-dimensional understanding and language processing, three-dimensional understanding is largely unexplored, particularly with respect to autonomous driving. One reason three-dimensional understanding is unexplored is there is a lack of large-scale labeled datasets, which are expensive and labor-intensive to create. Foundation model training typically utilizes millions to billions of labeled samples. However, three-dimensional data scene understanding training datasets range from a few thousand to a couple hundred thousand samples. The lack of comprehensive training datasets limits the performance and generalization capabilities of three-dimensional scene understanding, which is problematic for use with autonomous driving, which requires the ability to detect and respond to a wide range of objects, including unexpected objects.

Existing foundation models for three-dimensional perception tend to be camera-centric, relying primarily on visual data. Camera-based approaches can provide a level of three-dimensional understanding, but such approaches suffer from depth accuracy limitations. Three-dimensional sensors, including LiDAR, provide accurate depth and spatial information, which is needed for autonomous driving, among other things. However, a lack of a large and diverse training dataset associated with three-dimensional sensors, such as LiDAR, limits performance and generalization, which is unacceptable with respect to autonomous driving.

Aspects of the subject disclosure, address the aforementioned technical problems associated with three-dimensional scene understanding and perception with a technical solution that provides a two-stage training approach to develop a scalable foundation model. A foundation model can comprise a multimodal large language model (LLM) encoder, a fusion transformer, and a transformer decoder. In the first training stage, the foundation model is trained utilizing labeled three-dimensional data, such as a point cloud. The multimodal LLM encoder can be trained to generate text-based descriptions of objects in the three-dimensional data based on the labels, annotations, or metadata, the fusion transformer can be trained to combine the three-dimensional data with the text-based descriptions of objects in a multimodal representation, and the transformer decoder can be trained to perform one or more three-dimensional perception tasks based on the multimodal representation. In the second training stage, the foundation model can be further trained to enhance the model produced after the first training stage based on unlabeled three-dimensional data and self-supervised learning techniques. Furthermore, an online learning mechanism can be employed to handle unknown objects by flagging them for human review and updating the foundation model based on the human response.

Utilizing supervised learning on labeled three-dimensional data in the first training stage establishes a strong basis for three-dimensional perception. Employing self-supervised learning on unlabeled three-dimensional data in the second stage enables a foundation model to scale and adapt to a broad range of scenarios. Thus, by combining supervised learning on labeled three-dimensional data in the first training stage and self-supervised learning on large unlabeled datasets of three-dimensional data in the second training stage, a scalable foundation model for three-dimensional perception and understanding is produced. The addition of online learning allows a foundation model to continuously learn and adapt to new objects and scenarios. A three-dimensional foundation model is therefore generated that can operate in scenarios, such as autonomous driving, which benefits from accurate depth perception, adaptability to diverse environments, continuous learning, and scalability.

### Example Computing Device

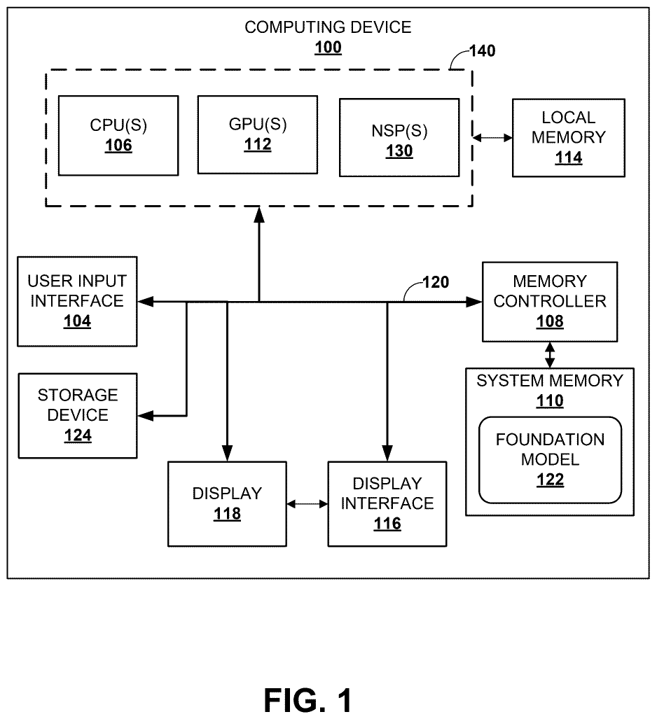

FIG. 1 is a block diagram illustrating an example computing device that may perform techniques of this disclosure. Computing device 100 may comprise a mobile device such as a smart phone, a mobile telephone, a cellular telephone, a satellite telephone, or a mobile telephone handset. Further, the computing device 100 may comprise a personal computer, a desktop computer, a laptop computer, a computer workstation, a video game platform or console, a landline telephone, an Internet telephone, a handheld device such as a portable video game device or a personal digital assistant (PDA), a personal music player, a video player, a display device, a television, a television set-top box, a server, an intermediate network device, a mainframe computer, a mobile computing device, a vehicle head unit, self-driving or autonomous driving vehicle, or a robot.

As illustrated in the example of FIG. 1, computing device 100 includes a user input interface 104, CPU(S) 106, memory controller 108, system memory 110, graphics processing unit (GPU) 112, neural network signal processor (NSP) 130, coding component 132, which may be implemented in NSP(S) 130, local memory 114, display interface 116, display 118, bus 120, and storage device(s) 124. User input interface 104, CPU(S) 106, memory controller 108, GPU(S) 112, coding component 132, NSP(S) 130, display interface 116, and storage device(s) 124 may communicate with each other using bus 120. Bus 120 may be any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXentisible Interface (AXI) bus) or another type of bus or device interconnect. It should be noted that the specific configuration of buses and communication interfaces between the different components shown in FIG. 1 is merely exemplary, and other configurations of computing devices and/or other graphics processing systems with the same or different components may be used to implement the techniques of this disclosure.

CPU(s) 106 may comprise one or more general-purpose and/or special-purpose processors that control operation of computing device 100. A user may provide input to computing device 100 to cause CPU(s) 106 to execute software including one or more of system software and application software. System software executing on CPU(s) 106 can manage and control computer hardware and provide a platform for running application software. Examples of system software may include an operating system, firmware, device drivers, and virtualization platforms. Application software, or software applications, that execute on CPU(s) 106 may include, for example, a word processor application, an email application, a spreadsheet application, a media player application, a video game application, a graphical user interface application, or other programs. The user may provide input to computing device 100 by way of one or more input devices (not shown), such as a keyboard, a mouse, a microphone, a touchpad, or another input device that is coupled to computing device 100 by way of the user input interface 104.

Memory controller 108 facilitates the transfer of data going into and out of system memory 110. For example, memory controller 108 may receive memory read and write commands, and service such commands with respect to system memory 110 to provide memory services for the components in computing device 100. Memory controller 108 is communicatively coupled to system memory 110. Although memory controller 108 is illustrated in the example computing device 100 of FIG. 1 as being a processing module that is separate from both CPU(s) 106 and system memory 110, in other examples, some or all of the functionality of memory controller 108 may be implemented on one or both of CPU(s) 106 and system memory 110.

System memory 110 may store program modules and/or instructions that are accessible for execution by CPU(s) 106 and/or data for use by the programs executing on CPU(s) 106. For example, system memory 110 may store user applications and graphics data associated with the applications. System memory 110 may additionally store information for use by and/or generated by other components of computing device 100. For example, system memory 110 may act as a device memory for one or more GPU(s) 112 and may store data to be operated on by GPU(s) 112 as well as data resulting from operations performed by GPU(s) 112. System memory 110 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 110 may include instructions that cause CPU(s) 106, GPU(s) 112, or NSP(s) 130 to perform the functions described in this disclosure to CPU(s) 106, GPU(s) 112, and NSP(s) 130. Accordingly, system memory 110 may be a computer-readable storage medium having instructions stored thereon that, when executed, cause one or more processors (e.g., CPU(s) 106, GPU(s) 112, NSP(s) 130) to perform various functions.

In some examples, system memory 110 is a non-transitory storage medium. The term “non-transitory” indicates that the storage medium is not embodied in a carrier wave or a propagated signal. However, the term “non-transitory” should not be interpreted to mean that system memory 110 is non-movable or that its contents are static. As one example, system memory 110 may be removed from computing device 100, and moved to another device. As another example, memory, substantially similar to system memory 110, may be inserted into computing device 100. In certain examples, a non-transitory storage medium may store data that can, over time, change (e.g., in RAM).

Storage device(s) 124 may include removable/non-removable, volatile/non-volatile storage media for storing vast amounts of data relative to system memory 110. For example, storage device(s) 124 may include, but are not limited to, one or more devices such as a magnetic or optical disk drive, flash memory, solid-state drive, or memory stick. Data may be saved or persisted to the storage device(s) 124 and later retrieved and loaded into system memory 110 for further processing. In accordance with one aspect of the subject disclosure, neural network values such as parameters, weights, and biases can saved to the storage device(s) 124.

GPU(s) 112 may be configured to perform graphics operations to render one or more graphics primitives to display 118. Thus, when one of the software applications executing on CPU(s) 106 requires graphics processing, CPU(s) 106 may provide graphics commands and graphics data to GPU(s) 112 for rendering to display 118. The graphics commands may include, e.g., drawing commands such as a draw call, GPU state programming commands, memory transfer commands, general-purpose computing commands, kernel execution commands, etc. In some examples, CPU(s) 106 may provide the commands and graphics data to GPU(s) 112 by writing the commands and graphics data to system memory 110, which may be accessed by GPU(s) 112. In some examples, GPU(s) 112 may be further configured to perform general-purpose computing for applications executing on CPU(s) 106.

GPU(s) 112 may, in some instances, be built with a highly parallel structure that provides more efficient processing of vector operations than CPU(s) 106. For example, GPU(s) 112 may include a plurality of processing elements that are configured to operate on multiple vertices or pixels in a parallel manner. The highly parallel nature of GPU(s) 112 may, in some instances, allow GPU(s) 112 to draw graphics images (e.g., GUIs and two-dimensional (2D) and/or three-dimensional (3D) graphics scenes) onto display 118 more quickly than drawing the scenes directly to display 118 using CPU(s) 106. In addition, the highly parallel nature of GPU(s) 112 may allow GPU(s) 112 to process certain types of vector and matrix operations for general-purpose computing applications more quickly than CPU(s) 106. In some examples, computing device 100 may make use of the highly parallel structure of GPU(s) 112 to perform parallel entropy coding.

GPU(s) 112 may, in some instances, be integrated into a motherboard of computing device 100. In other instances, GPU(s) 112 may be present on a graphics card that is installed in a port in the motherboard of computing device 100 or may be otherwise incorporated within a peripheral device configured to interoperate with computing device 100. In further instances, GPU(s) 112 may be located on the same microchip as CPU(s) 106 forming a system on a chip (SoC). GPU(s) 112 and CPU(s) 106 may include one or more processors, such as one or more microprocessors, application specific integrated circuits (ASICs), field programmable gate arrays (FPGAs), digital signal processors (DSPs), or other equivalent integrated or discrete logic circuitry.

CPU(s) 106, GPU(s) 112, and NSP(s) 130 may together be referred to as one or more processors 140. In describing the various techniques that may be performed by one or more processors 140, it should be understood that such techniques may be performed by one or more of CPU(s) 106, GPU(s) 112, and NSP(s) 130. It should be understood that the techniques disclosed herein are not necessarily limited to being performed by CPU(s) 106, GPU(s) 112, or NSP(s) 130, but may also be performed by any other suitable hardware, device, logic, circuitry, processing units, and the like of computing device 100.

GPU(s) 112 may be directly coupled to local memory 114. Thus, GPU(s) 112 may read data from and write data to local memory 114 without necessarily using bus 120. In other words, GPU(s) 112 may process data locally using a local storage, instead of off-chip memory. This allows GPU(s) 112 to operate in a more efficient manner by eliminating the need of GPU(s) 112 to read and write data via bus 120, which may experience heavy bus traffic. In some instances, however, GPU(s) 112 may not include a separate cache, but instead utilize system memory 110 via bus 120. Local memory 114 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media.

As described, CPU(s) 106 may offload graphics processing to GPU(s) 112, such as tasks that require massive parallel operations. As one example, graphics processing requires massive parallel operations, and CPU(s) 106 may offload such graphics processing tasks to GPU(s) 112. However, other operations such as matrix operations may also benefit from the parallel processing capabilities of GPU(s) 112. In these examples, CPU(s) 106 may leverage the parallel processing capabilities of GPU(s) 112 to cause GPU(s) 112 to perform non-graphics related operations.

CPU(s) 106, GPU(s) 112, and NSP(s) 130 may store rendered image data in a frame buffer that is allocated within system memory 110. Display interface 116 may retrieve the data from the frame buffer and configure display 118 to display the image represented by the rendered image data. In some examples, display interface 116 may include a digital-to-analog converter (DAC) that is configured to convert the digital values retrieved from the frame buffer into an analog signal consumable by display 118. In other examples, display interface 116 may pass the digital values directly to display 118 for processing.

Display 118 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display, an organic light-emitting-diode (OLED) display, or another type of display unit. Display 118 may be integrated within computing device 100. For instance, display 118 may be a screen of a mobile telephone handset or a tablet computer. Alternatively, display 118 may be a stand-alone device coupled to computing device 100 via a wired or wireless communications link. For instance, display 118 may be a computer monitor or flat panel display connected to a personal computer via a cable or wireless link.

System memory 110 may store foundation model 122 for three-dimensional scene understanding. The foundation model 122 may include one or more artificial neural networks (also referred to as neural networks) trained to receive input data of one or more types and to, in response, provide output data of one or more types.

In accordance with one aspect of the disclosure, the foundation model 122 may be implemented as or include one or more neural networks and may include a trainable or adaptive algorithm that utilizes nodes to transform inputs into outputs through learned parameters and activation functions. Each node can apply a mathematical function, such as a non-linear activation function, to process input data. Neural networks typically do not explicitly define logical rules, such as if-then rules. However, specialized or hybrid systems may incorporate rule-based reasoning alongside neural network structures.

A neural network may include three types of layers of nodes, namely an input layer, one or more hidden layers, and an output layer. The input layer may receive inputs, such as values from which the neural network as a whole generates an output. The output of each node of the input layer may be provided to each node of a first layer of hidden layers. Each input from the input layer may be multiplied by a neural network weight and then summed at each node of hidden layers. Such weights are determined or adjusted during training of neural network to establish a relationship between the input data and output data. Output of each node of the first hidden layer are provided to each node of a next hidden layer, and so on, when there are more than one hidden layer. The output layer may be provided with the output of each node of the last hidden layer. The output layer may include a transfer function and may output an inference, prediction, classification, etc. which is based on the input data and the neural network weights.

A respective node of a plurality of nodes of a layer may be connected to one or more different nodes of the plurality of nodes along an edge, such that the output of the respective node includes the input of the different node. The functions may include neural network weights that may be determined or adjusted using a training set of inputs and desired outputs along with a learning rule, such as a back-propagation learning rule. The back-propagation learning rule may utilize one or more error measurements comparing the desired output to the output produced by the neural network to train the neural network by varying the parameters to minimize the one or more error measurements.

In some examples, foundation model 122 is trained to perform classification of input data. That is, foundation model 122 can be trained to label input data to classify input data into one or more classes or categories by determining, for the input data, a confidence score for each of a plurality of classes that indicates a degree to which it is believed that the input data should be classified into the corresponding class. In other examples, foundation model 122 may determine a probabilistic distribution over a set of classes to indicate the probability that the input data belongs to each of the set of classes.

In some examples, foundation model 122 may be trained to perform computer vision tasks such as image classification, object detection, and/or image segmentation. Such computer vision tasks may be useful for computer vision applications such as autonomous driving. For example, foundation model 122 may be trained to perform image classification to determine which objects are in an image or video, such as by being trained to classify an image as either including a particular object or not including the particular object and by assigning one or more labels to the image. In another example, foundation model 122 may be trained to perform object detection to detect what objects are in an image or video and to specify where each of the objects is in the image, and foundation model 122 may be trained to assign one or more labels to each of the one or more objects in the image. In some examples, the foundation model 122 may be trained to perform image segmentation to separate an image into regions that delineate potentially meaningful areas for further processing.

### Example Foundation Model Implementation

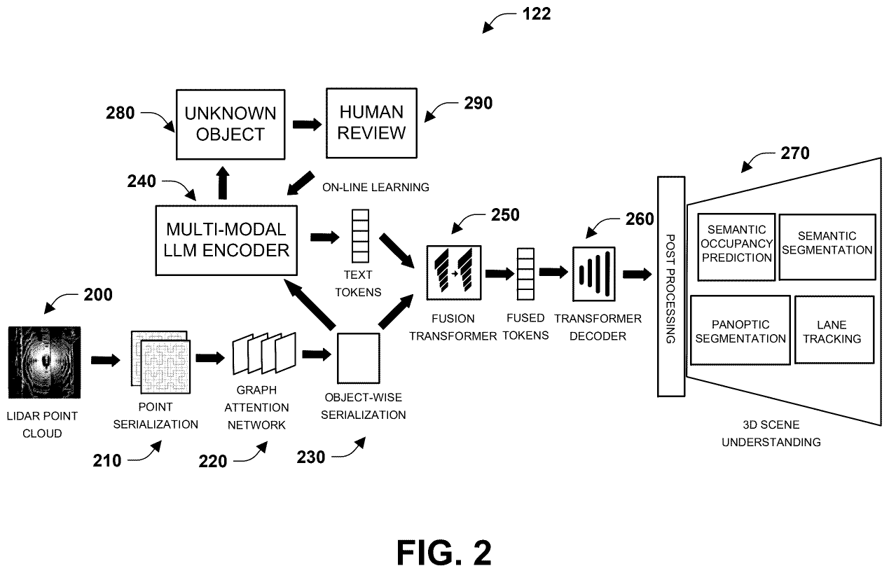

FIG. 2 is a diagram of an example implementation of a foundation model 122 in accordance with aspects of this disclosure. Foundation model 122 can receive three-dimensional sensor data as input. As illustrated, the three-dimensional sensor data can correspond to a point cloud 200. The point cloud 200 is a collection of data points in three-dimensional space that represents the locations of objects and surfaces within a scanned area. These points can be generated using light detection and ranging (LiDAR) technology that emits laser pulses and measures the time it takes for the light to reflect back to the sensor. The point cloud 200 can be represented in a format specific to LiDAR point clouds.

Point serialization 210 of the point cloud 200 can transform unstructured three-dimensional point data into a structured one-dimensional sequence. Point serialization enables more efficient processing and analysis of point cloud data. In one instance, the point cloud can be serialized using space-filling curves. The serialized representation reduces the complexity of three-dimensional point clouds by organizing points in a way that preserves spatial relationships and enables easier model processing.

Next, a graph attention network (GAT) 220 is applied to serialized point data. A graph attention network is a neural network architecture designed to process and analyze graph-structured data. The serialized points can be treated as nodes in a graph. Edges can be created between neighboring points in the serialized sequence. Each node's features include its three-dimensional coordinates and any additional attributes. The graph attention network operates on this graph structure and is configured to detect and classify objects within the larger point cloud. Stated differently, the graph attention network can be employed to extract representations of objects within a scene. Further, the graph attention network can retain connections between points that belong to individual objects.

Object-wise serialization 230 is applied next. Object-wise serialization is a process of converting an object's data, including properties and values into a structured format. This process is focused on serializing objects in the point cloud rather than serializing the entire point cloud. The graph attention network processes point cloud data, enhancing feature extraction and spatial relationships. Object-wise serialization can subsequently organize the features on a per-object basis. The process can lead to more efficient and effective processing of point cloud data downstream.

Multimodal large language model (LLM) encoder 240 is configured to receive, retrieve, or otherwise obtain serialized objects. A multimodal LLM encoder 240 can be a neural network architecture that is designed to process and integrate information from multiple data modalities beyond just text. Here, the multimodal LLM encoder 240 is trained to generate text-based descriptions of serialized objects. The text-based object descriptions are output as text tokens or an embedding.

Fusion transformer 250 is configured to receive, retrieve, or otherwise obtain the text tokens from the multimodal LLM encoder 240 and the objects produced by object-wise serialization. Fusion transformer 250 can be a neural network component designed to combine and integrate information from multiple modalities into a unified representation. Here, the fusion transformer 250 is trained to combine the objects and descriptions captured by the text tokens into a multimodal representation.

Transformer decoder 260 is configured to receive, retrieve, or otherwise obtain the multimodal representation. Transformer decoder 260 can be a component of a transformer-based neural network architecture responsible for generating an output given and input. Here, transformer decoder 260 is trained to generate three-dimensional perception outputs based on the multimodal representation. In one instance, the transformer decoder 260 produces the final three-dimensional segmentation of the input point cloud 200. Semantic labels can be assigned to every point in the cloud, effectively completing scene understanding.

As described above, a transformer architecture can be utilized in accordance with one aspect. However, similar results can also be achieved with graph networks, convolutional neural networks, or other attention mechanism network alternatives.

Through post-processing, including fine-tuning the foundation model, various three-dimensional scene understanding processes can be performed at 270, including lane tracking, semantic segmentation, panoptic segmentation, and semantic occupancy prediction.

In accordance with one aspect, a three-dimensional foundation model can include an online learning mechanism. For example, the multimodal LLM encoder may encounter an object that it cannot identify, namely unknown object 280. Human review 290 can be solicited by the multimodal LLM encoder 240. The user's feedback can identify the unknown object 280, which can be utilized by multimodal LLM encoder 240 to further train the multimodal LLM encoder 240, wherein the feedback corresponds to a label or annotation associated with an object.

### Example Foundation Model Training

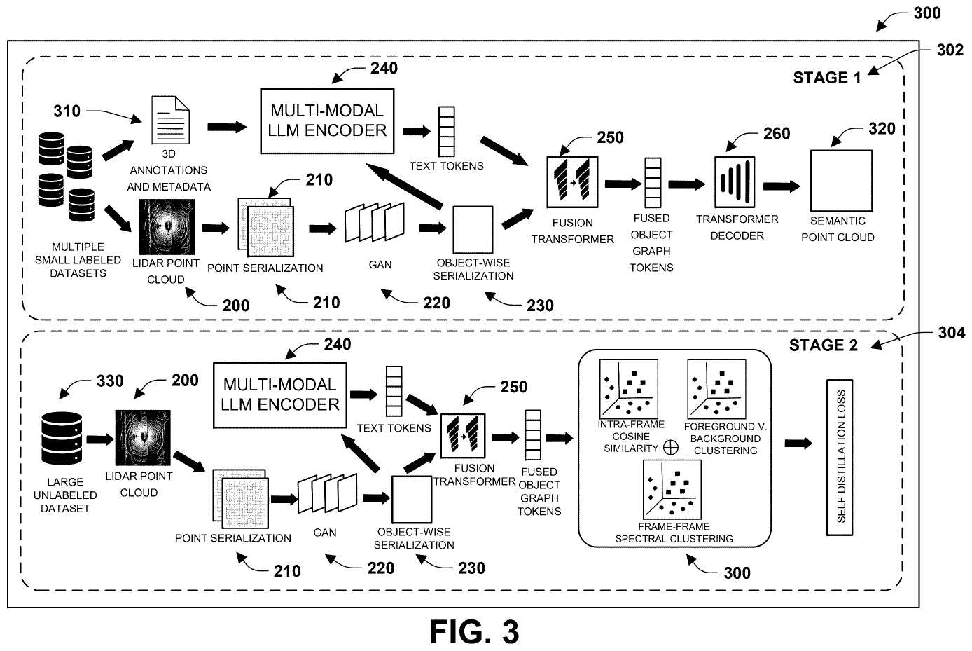

FIG. 3 illustrates an example of two-stage training of a foundation model. Stage one 302 training proceeds stage two 304, such that stage two training is able to exploit stage one 302 training. Stage one 302 performs supervised learning with respect to a labeled data set, and stage two 304 performs self-supervised learning with a larger unlabeled data set.

Stage one 302 starts with multiple small, labeled datasets comprising three-dimensional sensor data, here a LiDAR point cloud 200 and three-dimensional labels 310, for instance, including annotations and metadata regarding objects present in the point cloud 200. The labels 310 are provided to the multimodal LLM encoder 240 for subsequent processing. The point cloud 200 is preprocessed utilizing point serialization 210, graph attention network 220, and object-wise serialization 230.

Point serialization 210 is configured to transform unstructured three-dimensional point data into a structured one-dimensional sequence to enable more efficient processing and analysis of point cloud data. In one instance, the point cloud can be serialized using space-filling curves. The serialized representation reduces the complexity of three-dimensional point clouds by organizing points in a way that preserves spatial relationships and enables easier model processing.

A graph attention network (GAT) 220 is subsequently applied to serialized point cloud data. The serialized points can be treated as nodes in a graph with edges created between neighboring points in the serialized sequence. Each node's features include its three-dimensional coordinates and any additional attributes, such as intensity or color. The GAT 220 operates on this graph structure and is configured to detect and classify objects within the larger point cloud. Through its attention mechanism, the GAT 220 computes attention coefficients between connected nodes allowing it to focus on the most relevant spatial relationships and aggregate features effectively. The graph attention network can be employed to extract representations of objects within a scene. Further, the graph attention network can retain connections between points that belong to individual objects. By combining serialized point cloud data with a GAT 220, a framework is provided for object detection, classification, and representation in three-dimensional scenes.

Object-wise serialization 230 is applied after the GAT analysis of the point cloud. Object-wise serialization converts individual object data, including properties and values, into a structured format rather than serializing the entire point cloud. The graph attention network processes point cloud data, enhancing feature extraction and spatial relationships. Object-wise serialization can exploit GAT data to create serialized versions of each identified object, organizing object properties and values into a compact form for subsequent transmission and processing. The process can lead to more efficient and effective processing of point cloud data downstream.

Serialized versions of one or more objects in the point cloud 200 are provided to the multimodal LLM encoder 240. The multimodal LLM encoder 240 can be a pre-trained multimodal large language model that is fine-tuned, for instance, by way of supervised learning, based on object information as well as labels or other metadata associated with the object. For example, a traditional large language model can be fine-tuned to generate text descriptions of objects within a three-dimensional point cloud. As a result, the large language model becomes multimodal as it operates with multiple modalities (e.g., serialized objects) rather than just text. The multimodal LLM encoder 240 outputs text tokens, which can be words, parts of words, or individual characters. During training, the text tokens can represent a version of the labels or other metadata associated with the point cloud. In accordance with one aspect, input labels or annotations can be standardized by converting them into text embeddings (e.g., numerical representation of text that captures semantic meaning). These embeddings can enable generation of consistent representations across different datasets despite differences in terminology. Further, the output of the multimodal LLM encoder 240 can be an embedding, which are sometimes also referred to as tokens.

The fusion transformer 250 combines text tokens corresponding to a text-based description from the multimodal LLM encoder 240 with one or more serialized objects produced by object-wise serialization. The output is a multimodal representation, which corresponds to a unified representation of objects, where both the spatial relationships and semantic meaning are integrated. The fusion transformer 250 can be initially trained, or an existing fusion transformer can be fine-tuned to operate with respect to the current domain comprising text descriptions and objects as well as applications, such as autonomous driving.

The transformer decoder 260 is configured to receive, retrieve, or otherwise obtain the output of the fusion transformer 250. In response, the transformer decoder 260 is operable to output a final three-dimensional semantic segmentation 320 of the point cloud 200. The multimodal representation can be processed by transformer decoder 260 to extract and understand semantic and spatial information about objects in a three-dimensional scene. In one instance, semantic segmentation assigns a class, label, or category to each point in the point cloud, for example, indicating the type of object (e.g., car, pedestrian) to which the point belongs. Utilizing both semantic information from text-based object descriptions and spatial information from the point cloud a more accurate segmentation can be generated than an approach that relies on a single data modality.

The fusion transformer 250 can be trained to fuse text tokens and object serialization in stage one, so that the transformer decoder 260 can produce semantic labels. In accordance with one aspect, the fusion transformer 250 and the transformer decoder 260 learn to produce sematic segmentation output by fusing point cloud data and text annotations or descriptions in stage one.

In stage two 304, training builds on the training in stage one 302. Stage two 304 starts with large unlabeled datasets rather than the small, labeled data sets of stage one 302. Training on large unlabeled datasets allows the foundation model to scale and adapt to a much broader range of scenarios and environments. For example, autonomous driving applications require a model that performs reliably in diverse and dynamic conditions. Similar to stage one 302, three-dimensional sensor data, such as point cloud 200 from the large unlabeled dataset is preprocessed through point serialization 210, graph attention network 220, and object-wise serialization 230, as described above. The result of the preprocessing is serialized objects and object properties extracted from the point cloud 200. The objects and properties can be provided to the multimodal LLM encoder 240. The multimodal LLM encoder being trained in stage one 302 generates text-based descriptions of the objects and outputs text tokens or an embedding capturing the text tokens. Subsequently, the fusion transformer combines the text-based description and objects into a fused multimodal representation.

Without explicit labels, self-supervised learning can be performed the results of which can be utilized to fine-tune the transformer decoder 260. Self-supervised learning enables the foundation model to extract meaningful relationships from unlabeled sensor data, which can be utilized to enhance the performance of components such as the transformer encoder without relying on human-provided annotations. Stated differently, performing self-supervised learning on large amounts of data improves the generalizability of the model.

In accordance with one aspect, self-supervised learning can be employed to group points in point clouds. The points can be clustered based on intra frame grouping, which organizes points within a single frame, foreground versus background clustering, which distinguishes objects from the background, and frame-frame spectral clustering, which tracks points across frames for consistency.

One aim of intra-frame grouping or intra-point cloud clustering, is to distill the group assignment probability affinity matrix from the fused object graph tokens based on cosine similarity between the fused object graph tokens and a single point cloud. The group assignment probability matrix can be defined as the probability of a fused scene graph token (Pi) assigned to a group (Zi). To prevent dominant groups and better ensure balanced assignments, entropy regularization may be added. This regularization prevents one group from becoming overly dominant, ensuring that all object graph tokens are fairly distributed across groups. Self-distillation loss is used to constrain the assignment probability of object graph token to groups Z, based on the cosine similarity. Since the distillation is unsupervised and class-agnostic, the loss is computed for each point cloud.

To further enhance the model's ability to differentiate objects, self-learning techniques can be employed to separate the foreground and background points within the point cloud. This is significant for understanding which points belong to notable objects (e.g., vehicles, pedestrians) and which belong to the scene background (e.g., roads, trees). The fused object graph tokens can be fed through a sigmoid activation layer, which clusters the embeddings into two distinct groups: foreground and background. This binary classification helps the foundation model discern between the significant parts of the scene and the less significant surroundings. To ensure the embeddings for foreground and background remain distinct, a negative contrastive loss may be applied. This loss encourages the foreground and background voxel embeddings to be pushed apart, increasing the model's accuracy in separating these two groups.

To improve the model's ability to track objects across multiple frames and ensure that object graph tokens remain consistent over time, frame-to-frame spectral clustering can be performed. The object graph tokens in a single batch of point clouds can be clustered together through spectral clustering. Spectral clustering groups similar object graph tokens together and ensures consistency across frames. Next, the Graph CNN can be updated to maximize the assignment probability affinity matrix δi,j for similar object graph tokens. This step ensures that objects appearing in different frames are correctly grouped together, improving the model's ability to track and identify objects over time.

By the end of stage two 304, the foundation model is capable of performing a wide range of 3D scene understanding tasks, including 3D semantic segmentation, 3D occupancy prediction, 3D lane tracking, and 3D panoptic segmentation. These tasks can be achieved with minimal post-processing, enabling versatility and scalability.

### Example Foundation Model Methods

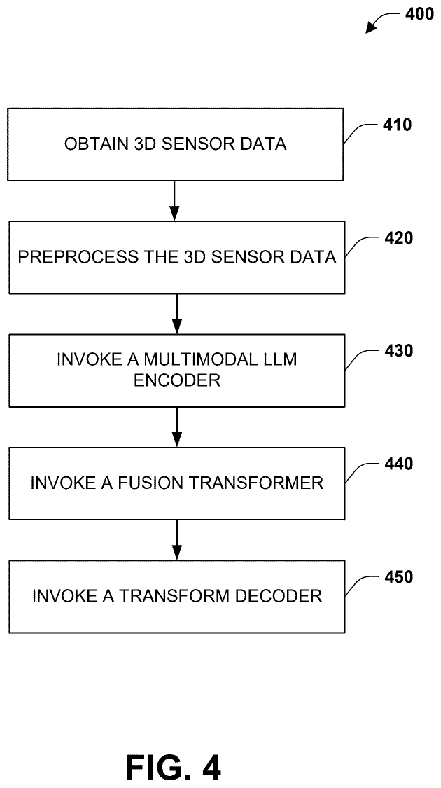

FIG. 4 depicts an example method 400 of foundation model inferencing. Method 400 starts at block 410 with obtaining three-dimensional sensor data. In one instance, the three-dimensional sensor data can be a point cloud produced by a LiDAR sensor. However, the three-dimensional sensor data can be in a different form and provided by a different sensor or system, such as radar, sonar, time-of-flight (ToF) cameras, structured light sensors, and stereo vision cameras, among others.

Method 400 continues to block 420 with preprocessing the three-dimensional sensor data. Preprocessing can involve identifying one or more objects and corresponding features captured by the three-dimensional sensor data. By way of example, and not limitation, preprocessing can include serializing a point cloud produce by a LiDAR sensor, applying a graph attention network to identify objects and corresponding features, and performing object-wise serialization to serialize the objects identified by the graph attention network.

Method 400 continues to block 430 with invoking a multimodal LLM encoder. The multimodal LLM encoder is configured and trained to generate text-based descriptions of objects. The model can be invoked on one or more objects captured during preprocessing of three-dimensional sensor data. In one instance, the text-based description of an object can be captured by an embedding or series of text tokens.

Method 400 proceeds to block 440 with invoking a fusion transformer. A fusion transformer is configured and trained to combine objects and descriptions of objects into a multimodal representation. For example, the fusion transformer can combine an object identified in three-dimensional sensor data with a description of the object generated by the multimodal LLM encoder.

Method 400 continues to block 450 by invoking a transform decoder. The transform encoder is configured and trained to perform one more three-dimensional perception task based on information encoded in the multimodal representation produced by the fusion transformer. For example, the transform decoder can output semantic segmentation that classifies points in a three-dimensional scene into an appropriate object category (e.g., car, building, pedestrian).

Note that FIG. 4 is just one example of a method, and other methods including fewer, additional, or alternative operations are possible consistent with this disclosure.

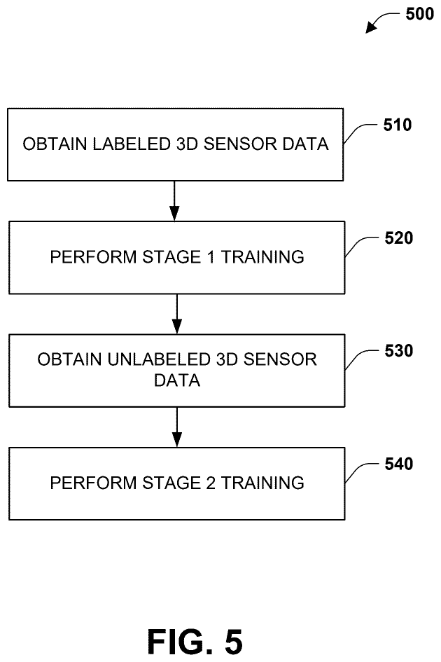

FIG. 5 depicts an example method 500 for training a three-dimensional foundation model. Method 500 starts at block 510 with receiving, retrieving, or otherwise obtaining labeled three-dimensional (3D) sensor data. The labeled three-dimensional sensor data can be labeled with object-level classifications or categories, among other things.

Method 500 continues at block 520 with performing stage one training. Stage one training of a foundation model can correspond to employing supervised learning using the labeled three-dimensional sensor data to train the foundation model.

Method 500 continues at block 530 with receiving, retrieving, or otherwise obtaining unlabeled three-dimensional sensor data. In other words, any labels or annotations are absent from the sensor data.

Method 500 continues at block 530 with performing stage two training. Stage two training involves utilizing self-supervised learning with respect to the unlabeled data to train the foundation model.

Note that FIG. 5 is just one example of a method, and other methods including fewer, additional, or alternative operations are possible consistent with this disclosure.

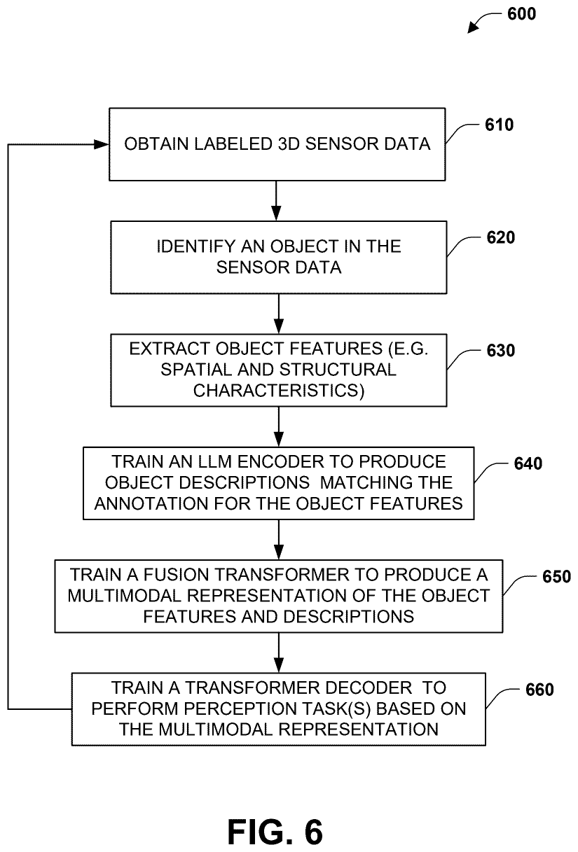

FIG. 6 depicts an example method 600 of stage one training. Method 600 begins at block 610 with receiving, retrieving, or otherwise obtaining a labeled three-dimensional (3D) sensor data. By way of example, and not limitation, the sensor data can be a point cloud produced by a LiDAR sensor. The labeled 3D sensor data corresponds to training data with respect to a foundation model with supervised learning.

Method 600 continues at block 620 with identifying an object in the sensor data. In accordance with one aspect, a graph attention network (GAT) can be employe to identify the objects. For example, points of a point cloud can be treated as nodes in a graph with edges created between neighboring points in the serialized sequence. The GAT operates on this graph structure and is configured to detect and classify objects within the larger point cloud.

Method 600 continues at block 630 with extracting object features such as spatial and structural characteristics. Similar to the method 600 of block 620, a graph attention network can be utilized to extract such features. Again, points of a point cloud can be treated as nodes in a graph with edges created between neighboring points in the serialized sequence. Each node's features include its three-dimensional coordinates and any additional attributes, such as intensity or color. The GAT operates on this graph structure and is configured to detect and classify objects within the larger point cloud. Through its attention mechanism, the GAT computes attention coefficients between connected nodes allowing it to focus on the most relevant spatial relationships and aggregate features effectively. The graph attention network can be employed to extract representations of objects within a scene.

Method 600 continues at block 640 with training a multimodal LLM encoder to produce object descriptions matching the labels, annotations, or metadata associated with corresponding three-dimensional sensor data. The multimodal LLM encoder can learn to generate descriptive text for sensor data such as a point cloud based on the labels, annotations, or metadata through supervised learning.

Method 600 continues at block 650 with training a fusion transformer to produce a multimodal representation of the object features and text descriptions.

Method 600 continues at block 660 with training a transformer decoder to perform perception tasks based on a multimodal representation. In accordance with one aspect, the transformer decoder can be trained to output a semantic segmentation that assigns a class, label, or category to each point in the point cloud, for example, indicating the type of object (e.g., car, pedestrian, building) to which the point belongs.

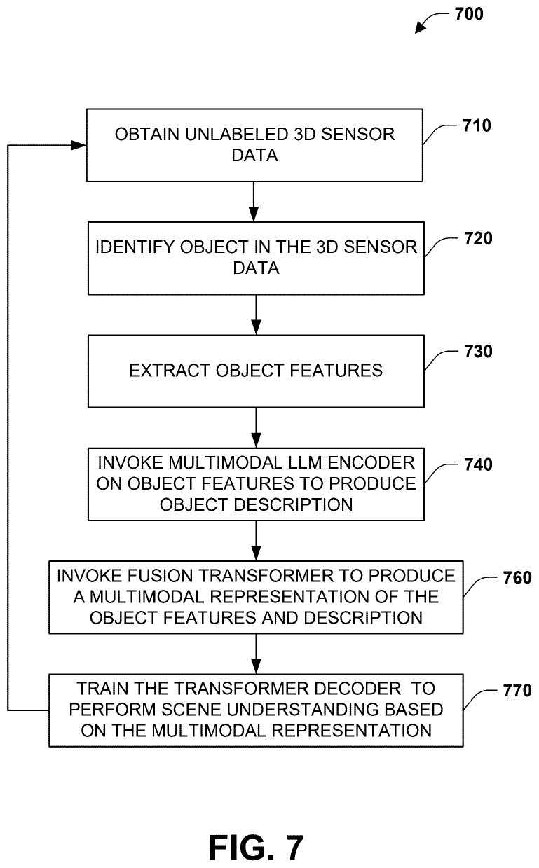

FIG. 7 depicts an example method 700 of stage two training in accordance with one aspect. Method 700 begins at block 710 with receiving, retrieving, or otherwise obtaining unlabeled three-dimensional (3D) sensor data. By way of example, and not limitation, the sensor data can be a point cloud produced by a LiDAR sensor.

Method 700 continues at block 720 with identifying an object in the 3D sensor data. In accordance with one aspect, a graph attention network (GAT) can be employed to identify the objects. For example, points of a point cloud can be treated as nodes in a graph with edges created between neighboring points in the serialized sequence. The GAT operates on this graph structure and is configured to detect and classify objects within the larger point cloud.

Method 700 continues at block 730 with extracting object features. In accordance with one aspect, a graph attention network can be utilized to extract such features. Again, points of a point cloud can be treated as nodes in a graph with edges created between neighboring points in the serialized sequence. Each node's features include its three-dimensional coordinates and any additional attributes, such as intensity or color. The GAT operates on this graph structure and is configured to detect and classify objects within the larger point cloud. Through its attention mechanism, the GAT computes attention coefficients between connected nodes allowing it to focus on the most relevant spatial relationships and aggregate features effectively. The graph attention network can be employed to extract representations of objects within a scene.

Method 700 continues at block 740 with invoking a multimodal LLM encoder on an object and object features to produce a text-based object description. For example, the multimodal LLM encoder can be trained in stage one and employed in stage two to produce a text-based description from an object in the form of text tokens or an embedding.

Method 700 continues at block 760 with invoking a fusion transformer. The fusion transformer is configured to combine an object and feature with a text-based description provided by the multimodal LLM encoder. The result is a fused multimodal representation of the object and description.

Method 700 continues at block 770 with training the transformer decoder to perform three-dimensional scene understanding. Self-supervised learning can be performed and utilized to enhance the transformer decoder 260. Self-supervised learning enables the foundation model to extract meaningful relationships from unlabeled sensor data, which can be utilized to enhance the performance of components such as the transformer encoder without relying on human-provided annotations. In accordance with one aspect, self-supervised learning can be employed to group points in point clouds. The points can be clustered based on intra-frame grouping, which organizes points within a single frame; foreground versus background clustering, which distinguishes objects from the background; and frame-frame spectral clustering, which tracks points across frames for consistency.

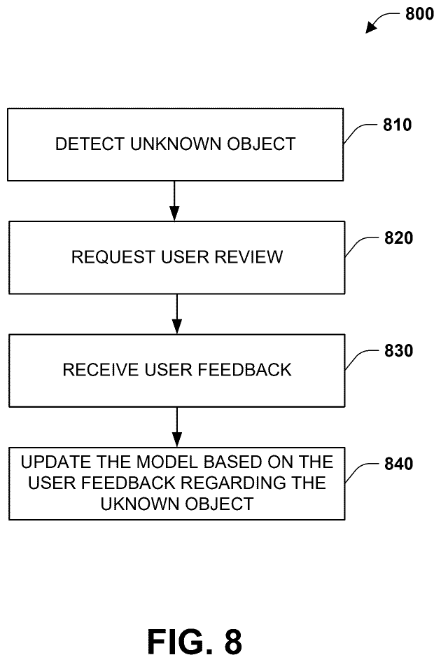

FIG. 8 depicts an example method 800 of online learning. Method 800 begins at block 810 with detecting an unknown object. In accordance with one aspect, a multimodal LLM encoder can be employed by a foundation model to generate text-based descriptions of objects captured within three-dimensional sensor data, such as a point cloud. The multimodal LLM encoder can be trained with a limited set of labeled sensor data. Accordingly, there may be cases in which the multimodal LLM encoder cannot recognize an object. In that case, the object can be flagged as an unknown object in one embodiment.

Method 800 continues at block 820 with requesting user review of the object. Flagging an object as an unknown object can trigger a human-in-the-loop review process. The flagged object can be presented to a human (e.g., user, expert) for feedback on the object.

Method 800 continues at block 830 with receiving user feedback regarding the object. After receiving a request, a human reviewer can examine the unknown object and provide information such as a description or label for the object, an object class or category, or other information regarding object characteristics.

Method 800 continues at block 840 with updating the model based on user feedback regarding the unknown object. For example, a multimodal LLM encoder can be updated to incorporate the provided feedback about a previously unknown object. By incorporating human feedback, a foundation model can continuously expand its knowledge and recognition capabilities.

Note that FIG. 8 is just one example of a method, and other methods including fewer, additional, or alternative operations are possible consistent with this disclosure.

### Example Clauses

Implementation examples are described in the following numbered clauses:

Clause 1: A method, comprising: obtaining labeled three-dimensional sensor data; training a foundation model on three-dimensional scene understanding based on the labeled three-dimensional sensor data a first training stage, wherein the foundation model comprises a multimodal large language model (LLM) encoder, a fusion transformer, and a transformer decoder; obtaining unlabeled three-dimensional sensor data; and training the foundation model trained in the first training stage based on the unlabeled three-dimensional sensor data in a second training stage.

Clause 2: The method of Clause 1, wherein training the foundation model in the first training stage further comprises: training the multimodal LLM encoder to generate text-based object descriptions based on object features extracted from the three-dimensional sensor data and corresponding labels; training the fusion transformer to combine the text-based object descriptions with the object features in a multimodal representation; and training the transformer decoder to perform one or more three-dimensional perception tasks based on the multimodal representation.

Clause 3: The method of Clauses 1-2, wherein training the foundation model in the second training stage further comprises training the transformer decoder to perform one or more three-dimensional perception tasks based on the multimodal representation.

Clause 4: The method of Clauses 1-3, wherein training the transformer decoder to perform one or more three-dimensional perception tasks comprises training the transformer decoder to perform foreground and background separation to separate objects that appear in the foreground and background of the unlabeled three-dimensional sensor data.

Clause 5: The method of Clauses 1-4, wherein training the transformer decoder to perform one or more three-dimensional perception tasks comprises training the transformer decoder to perform frame-to-frame spectral clustering.

Clause 6: The method of Clauses 1-5 further comprising training the multimodal LLM encoder to recognize unseen objects based on user input after the first training stage and the second training stage.

Clause 7. The method of Clauses 1-6, wherein the three-dimensional sensor data comprises a point cloud.

Clause 8: The method of Clauses 1-7, wherein training the transformer decoder to perform one or more three-dimensional perception tasks comprises training the transformer decoder to perform intra-point cloud clustering to organize points within a single frame.

Clause 9: An apparatus comprising one or more memories, processing circuitry in communication with the one or more memories, the processing circuitry configured to: obtain labeled three-dimensional sensor data, train a foundation model on three-dimensional scene understanding based on the labeled three-dimensional sensor data in a first training stage, wherein the foundation model comprises a multimodal large language model (LLM) encoder, a fusion transformer, and a transformer decoder, obtain unlabeled three-dimensional sensor data, and train the foundation model trained in the first training stage based on the unlabeled three-dimensional sensor data in a second training stage.

Clause 10: The apparatus of Clause 9, wherein train the foundation model in the first training stage further comprises train the multimodal LLM encoder to generate text-based object descriptions based on object features extracted from three-dimensional sensor data and corresponding labels, train the fusion transformer to combine the text-based object descriptions with the object features in a multimodal representation, and train the transformer decoder to perform one or more three-dimensional perception tasks based on the multimodal representation.

Clause 11: The apparatus of Clauses 9-10, wherein train the foundation model in the second training stage comprises train the transformer decoder to perform one or more three-dimensional perception tasks based on the multimodal representation.

Clause 12: The apparatus of Clauses 9-11, wherein one of the one or more three-dimensional perception tasks comprises foreground and background separation to separate objects that appear in the foreground and background.

Clause 13: The apparatus of Clauses 9-12, wherein one of the one or more three-dimensional perception tasks comprises frame-to-frame spectral clustering to track points across frames.

Clause 14: The apparatus of Clauses 9-13, wherein the processing circuitry is further configured to train the multimodal LLM encoder to recognize objects based on user input after the first training stage and second training stage.

Clause 15: The apparatus of Clauses 9-14, wherein the three-dimensional sensor data comprises a point cloud.

Clause 16: The apparatus of Clauses 9-15, wherein one of the one or more three-dimensional perception tasks comprises intra-point cloud clustering to organize points within a single frame.

Clause 17: A method comprising obtaining three-dimensional sensor data, identifying one or more objects in the three-dimensional sensor data, determining one or more object features of the one or more objects, invoking a multimodal large language model (LLM) encoder that generates one or more text-based object descriptions of one or more objects in the three-dimensional sensor data, invoking a fusion transformer that combines object features and the one or more text-based object descriptions to produce a multimodal representation, and invoking a transformer decoder that performs a three-dimensional perception task based on multimodal representation.

Clause 18: The method of Clause 17, wherein the multimodal LLM encoder, fusion transformer, and transformer decoder were trained based on labeled three dimensional sensor data in a first training stage prior to invoking the multimodal LLM encoder, fusion transformer, transformer decoder.

Clause 19: The method of Clauses 17-18, wherein the transformer decoder was trained based on unlabeled three-dimensional sensor data in a second training stage after the first training stage and prior to invoking the fusion transformer and transformer decoder.

Clause 20: The method of Clauses 17-19, wherein the three-dimensional sensor data comprises a point cloud generated by a light detection and ranging (LiDAR) sensor.

Clause 21: An apparatus comprising: one or more memories; processing circuitry in communication with the one or more memories, the processing circuitry configured to perform a method in accordance with any one of Clauses 1-20.

Clause 21: A processing system, comprising: a memory comprising computer-executable instructions; and a processor configured to execute the computer-executable instructions and cause the processing system to perform a method in accordance with any one of Clauses 1-20.

Clause 22: A processing system, comprising means for performing a method in accordance with any one of Clauses 1-20.

Clause 23: A non-transitory computer-readable medium storing program code for causing a processing system to perform the steps of any one of Clauses 1-20.

Clause 24: A computer program product embodied on a computer-readable storage medium comprising code for performing a method in accordance with any one of Clauses 1-20.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
obtaining labeled three-dimensional sensor data;
training a foundation model on three-dimensional scene understanding based on the labeled three-dimensional sensor data a first training stage, wherein the foundation model comprises a multimodal large language model (LLM) encoder, a fusion transformer, and a transformer decoder;
obtaining unlabeled three-dimensional sensor data; and
training the foundation model trained in the first training stage based on the unlabeled three-dimensional sensor data in a second training stage.

2. The method of claim 1, wherein training the foundation model in the first training stage further comprises:
training the multimodal LLM encoder to generate text-based object descriptions based on object features extracted from the three-dimensional sensor data and corresponding labels;
training the fusion transformer to combine the text-based object descriptions with the object features in a multimodal representation; and
training the transformer decoder to perform one or more three-dimensional perception tasks based on the multimodal representation.

3. The method of claim 2, wherein training the foundation model in the second training stage further comprises training the transformer decoder to perform one or more three-dimensional perception tasks based on the multimodal representation.

4. The method of claim 3, wherein training the transformer decoder to perform one or more three-dimensional perception tasks comprises training the transformer decoder to perform foreground and background separation to separate objects that appear in the foreground and background of the unlabeled three-dimensional sensor data.

5. The method of claim 3, wherein training the transformer decoder to perform one or more three-dimensional perception tasks comprises training the transformer decoder to perform frame-to-frame spectral clustering.

6. The method of claim 1, further comprising training the multimodal LLM encoder to recognize unseen objects based on user input after the first training stage and the second training stage.

7. The method of claim 1, wherein the three-dimensional sensor data comprises a point cloud.

8. The method of claim 7, wherein training the transformer decoder to perform one or more three-dimensional perception tasks comprises training the transformer decoder to perform intra-point cloud clustering to organize points within a single frame.

9. An apparatus, comprising:
one or more memories;
processing circuitry in communication with the one or more memories, the processing circuitry configured to:
obtain labeled three-dimensional sensor data;
train a foundation model on three-dimensional scene understanding based on the labeled three-dimensional sensor data in a first training stage, wherein the foundation model comprises a multimodal large language model (LLM) encoder, a fusion transformer, and a transformer decoder;
obtain unlabeled three-dimensional sensor data; and
train the foundation model trained in the first training stage based on the unlabeled three-dimensional sensor data in a second training stage.

10. The apparatus of claim 9, wherein train the foundation model in the first training stage further comprises:
train the multimodal LLM encoder to generate text-based object descriptions based on object features extracted from three-dimensional sensor data and corresponding labels;
train the fusion transformer to combine the text-based object descriptions with the object features in a multimodal representation; and
train the transformer decoder to perform one or more three-dimensional perception tasks based on the multimodal representation.

11. The apparatus of claim 10, wherein train the foundation model in the second training stage comprises train the transformer decoder to perform one or more three-dimensional perception tasks based on the multimodal representation.

12. The apparatus of claim 11, wherein one of the one or more three-dimensional perception tasks comprises foreground and background separation to separate objects that appear in the foreground and background.

13. The apparatus of claim 11, wherein one of the one or more three-dimensional perception tasks comprises frame-to-frame spectral clustering to track points across frames.

14. The apparatus of claim 9, wherein the processing circuitry is further configured to train the multimodal LLM encoder to recognize objects based on user input after the first training stage and second training stage.

15. The apparatus of claim 11, wherein the three-dimensional sensor data comprises a point cloud.

16. The apparatus of claim 15, wherein one of the one or more three-dimensional perception tasks comprises intra-point cloud clustering to organize points within a single frame.

17. A method, comprising:
obtaining three-dimensional sensor data;
identifying one or more objects in the three-dimensional sensor data;
determining one or more object features of the one or more objects;
invoking a multimodal large language model (LLM) encoder that generates one or more text-based object descriptions of one or more objects in the three-dimensional sensor data;
invoking a fusion transformer that combines object features and the one or more text-based object descriptions to produce a multimodal representation; and
invoking a transformer decoder that performs a three-dimensional perception task based on multimodal representation.

18. The method of claim 17, wherein the multimodal LLM encoder, fusion transformer, and transformer decoder were trained based on labeled three dimensional sensor data in a first training stage prior to invoking the multimodal LLM encoder, fusion transformer, transformer decoder.

19. The method of claim 18, wherein the transformer decoder was trained based on unlabeled three-dimensional sensor data in a second training stage after the first training stage and prior to invoking the fusion transformer and transformer decoder.

20. The method of claim 17, wherein the three-dimensional sensor data comprises a point cloud generated by a light detection and ranging (LiDAR) sensor.
